(19) United States
(12) Patent Application Publication
(10) Pub. No.: US 2025/0266945 A1
(43) Pub. Date: Aug. 21, 2025

(54) SIGNALING METHODS FOR OCC-ENABLED PUSCH

(71) Applicant: Nokia Technologies Oy, Espoo (FI)

(72) Inventors: Mahdi AZARI, Massy (FR); Alessio MARCONE, Munich (DE); Frank FREDERIKSEN, Aalborg (DK); Ilari VANHAMÄKI, Tampere (FI)

(21) Appl. No.: 19/053,809

(22) Filed: Feb. 14, 2025

(30) Foreign Application Priority Data
Feb. 19, 2024 (FI) 20245203

(51) Int. Cl. H04L 5/00; H04W 72/21

(52) U.S. Cl. CPC H04L 5/0016; H04W 72/21

(57) ABSTRACT

An apparatus including means for receiving a configuration of orthogonal cover code operation; means for determining an orthogonal cover code to use for a physical uplink shared channel transmission, based on the configuration; and means for performing the physical uplink shared channel transmission using the determined orthogonal cover code.

### TECHNICAL FIELD

The examples and non-limiting example embodiments relate generally to communications and, more particularly, to signaling methods for OCC-enabled PUSCH.

### BACKGROUND

It is known for a communication device to gain access to a communication network via an access network node.

### SUMMARY

In accordance with an aspect, an apparatus include means for receiving a configuration of orthogonal cover code operation; means for determining an orthogonal cover code to use for a physical uplink shared channel transmission, based on the configuration; and means for performing the physical uplink shared channel transmission using the determined orthogonal cover code.

In accordance with an aspect, an apparatus includes means for transmitting, to a user equipment, a configuration of orthogonal cover code operation; and means for receiving, from the user equipment, a physical uplink shared channel transmission with use of an orthogonal cover code, based on the configuration.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 shows an example of OCC of length 2 for 2 UEs doing 2 PUSCH repetitions in the same time-frequency resources

FIG. 3 shows signaling OCC using RRC and DCI fields.

FIG. 4 shows signaling OCC when code sets at UEs are pre-defined by specification.

FIG. 5 is an example apparatus configured to implement the examples described herein.

FIG. 6 shows a representation of an example of non-volatile memory media used to store instructions that implement the examples described herein.

FIG. 7 is an example method, based on the examples described herein.

FIG. 8 is an example method, based on the examples described herein.

FIG. 9 shows an example orthogonal cover code configuration.

### DETAILED DESCRIPTION OF EXAMPLE EMBODIMENTS

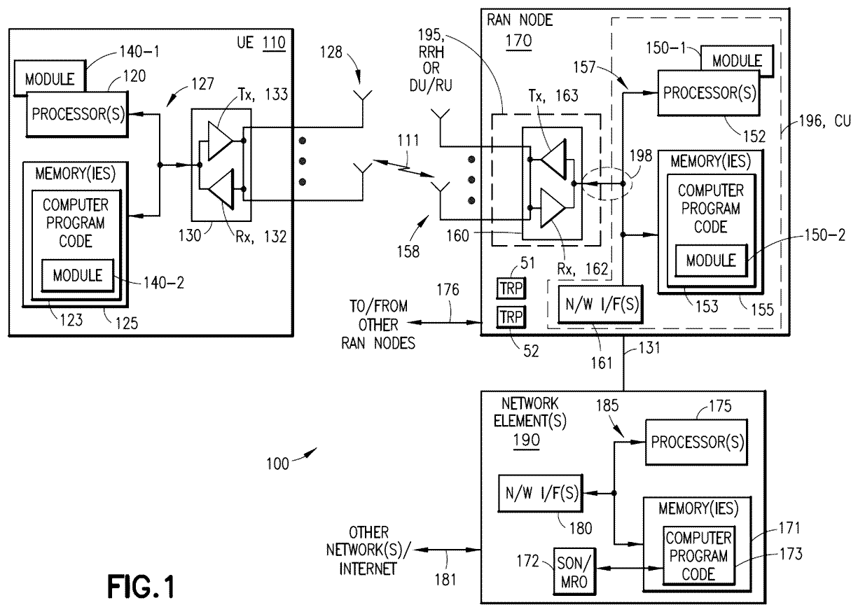

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, one or more memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises TRP 51 and TRP 52, in addition to the TRP represented by transceiver 160. Similar to transceiver 160, TRP 51 and TRP 52 may each include a transmitter and a receiver. The RAN node 170 may host or comprise other TRPs not shown in FIG. 1.

A relay node in NR is called an integrated access and backhaul node. A mobile termination part of the IAB node facilitates the backhaul (parent link) connection. In other words, the mobile termination part comprises the functionality which carries UE functionalities. The distributed unit part of the IAB node facilitates the so called access link (child link) connections (i.e. for access link UEs, and backhaul for other IAB nodes, in the case of multi-hop IAB). In other words, the distributed unit part is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (mobility management entity)/SGW (serving gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an SI interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, or a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback devices having wireless communication capabilities, internet appliances including those permitting wireless internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV. The user equipment 110 may be terminal device, such as mobile phone, mobile device, sensor device etc., the terminal device being a device used by the user or not used by the user.

UE 110, RAN node 170, and/or network element(s) 190, (and associated memories, computer program code and modules) may be configured to implement (e.g. in part) the methods described herein. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

Background on Rel-19 NTN uplink capacity enhancements

In RAN #102, a new Work Item Description (WID) for NTN targeting NR Rel-19 was approved in RP-234078. Among the objectives of the WI, an objective on Uplink Capacity/Throughput Enhancement for FR1-NTN was approved:

Uplink Capacity/Throughput Enhancement
for FR1-NTN [RAN1, RAN2, RAN4]

```
Study then specify, if beneficial, DFT-s-OFDM PUSCH enhancements via
Orthogonal Cover Codes (OCC)
  Determine the achievable capacity improvement to be targeted taking
  into account realistic impairments (e.g. Doppler, time variation, phase
  distortion, etc)
  Specify necessary signalling, if needed
  Update RF requirements accordingly, if needed
  Note: The study can consider orthogonal cover codes across OFDM
  symbols, across slots, and/or within an OFDM symbol.
  Note: the study phase is targeted to be completed by RAN#104
Notes for this objective:
  The enhancement is not targeting improvements/impacts of MU-
  MIMO capability
  The enhancement is not targeted to PUSCH DMRS
  No enhancement for initial access
  Enhancements to PRACH are not in scope.
  This feature may be applicable for UEs operating in terrestrial networks
  based on a common design
```

More specifically, this objective targets enhancements to the DFT-s-OFDM PUSCH channel via Orthogonal Cover Codes (OCC) to enable multiplexing of multiple UEs in the same time-frequency resources. As can be seen from the description of the objective, the study can consider orthogonal cover codes across OFDM symbols, across slots, and/or within an OFDM symbol, but the examples described herein specifically focus on the OCC application across intra-slot or inter-slot PUSCH repetitions, i.e. across OFDM symbols and across slots.

### Background on OCC

OCC is a coding technique that can be used to enhance the capacity/throughput of a cellular network. In particular, one could generate a set of orthogonal codes (e.g. Walsh-Hadamard codes) having ideal zero cross-correlation and assign different codes to different UEs to achieve orthogonal (i.e. no interference) UL transmissions on the same time-frequency resources.

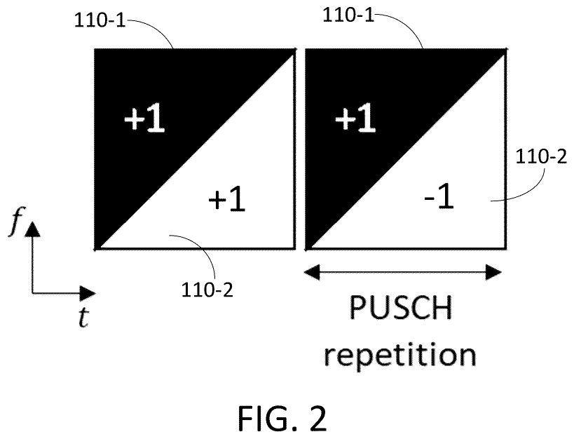

FIG. 2 illustrates the principle of OCC. FIG. 2 shows an example of OCC of length 2 for 2 UEs doing 2 PUSCH repetitions in the same time-frequency resources. In FIG. 2, two UEs are transmitting 2 PUSCH repetitions in the same time-frequency resources. For the transmissions, the two UEs apply different OCCs to their transmission signal (which is assumed here to stay constant across the repetitions) allowing a gNB receiver to receive (i.e. demodulate and decode) the signals of each UE without the interference of the other UE. In mathematical form, how this works is represented in the system of equation 1 below (without channel impairments and additive noise for simplicity of description) where x1 and x2 are the signals transmitted by UE1 and UE2, respectively and in both repetitions, whereas y1 and y2 are the total signals received by the gNB in the first and second repetition, respectively. It is to be noted that in this example UE1 110-1 is applying the OCC [1, 1] whereas UE2 is applying the OCC [1,−1]. In the example of the equations, gNB 170 retrieves the signal of UE2 110-2 without interference from UE1 110-1 by cross-correlating the two received signal y1 and y2 with the OCC used by UE2 (i.e. [1,−1]).

$$\{ \begin{matrix}{y}_{1} = ( + 1 ) * {x}_{1} + ( + 1 ) * {x}_{2} \\ {y}_{2} = ( + 1 ) * {x}_{1} + ( - 1 ) * {x}_{2}\end{matrix} \to ( + 1 ) * {y}_{1} + ( - 1 ) * {y}_{2} = 2 * {x}_{2} \qquad Eq . ( 1 )$$

The example above is only illustrative and uses Walsh-Hadamard orthogonal codes as OCC set. Different sequences can be used to realize orthogonality among users without impacting the applicability of the method described herein. In addition, it is to be noted that in general in order to multiplex N UEs a number of at least N PUSCH (or signal) repetitions are necessary.

UE1 110-1 and UE2 110-2 are configured similar to UE 110 as shown in FIG. 1 with connection to radio access network node 170 (e.g. gNB 170).

5G NR up to Rel-18 supports OCC for the part of a PUSCH that carries DM-RS. However, 5G NR up to Rel-18 does not support OCC for the part of the PUSCH used for data transmissions. Therefore indication of OCC operation to Rel-19 UEs needs to be introduced to enable orthogonal transmission of multiple UEs over the same time frequency resources. It is indeed fundamental that UEs scheduled in the same time frequency resources use different (and orthogonal) codes for their transmissions, and this can be guaranteed via gNB indication and management of UEs OCC code selection.

Described herein are methods for signaling and indication of both UE capability of support of OCC operation and configuration of a UE with OCC operation, including indication of the length of and the actual OCC code the UE should apply to PUSCH repetitions, and the position of the OCC with respect to repetitions.

Described herein are signaling methods to apply OCC to UEs data in uplink (i.e. PUSCH). This signaling indicates whether or not a UE is to use OCC for its uplink data transmission as well as which OCC code has to be used of which length and where the OCC code is located.

For this described herein are the following signaling methods: UE indication of supporting capability of OCC application to PUSCH transmissions, and gNB indication and configuration of a UE with OCC operation for PUSCH transmissions.

Regarding UE indication of supporting capability of OCC application to PUSCH transmissions, in one embodiment, the capability of applying OCC is limited to PUSCH repetitions. In another embodiment, the capability of applying OCC applies to DFT-s-OFDM PUSCH transmissions.

Regarding gNB indication and configuration of a UE with OCC operation for PUSCH transmissions, in one embodiment, UE is configured to use OCC and the length of the OCC to use via RRC (semi-static) signalling. In one alternative of this embodiment, UE is further RRC configured which OCC code to use among the code set with the configured length. In another alternative, which OCC code to use (among the code set with the configured length) is indicated to the UE dynamically via DCI-either via a new DCI field or via repurposing an existing DCI field. The DCI field can further indicate an offset that specifies the OCC elements (or code) position with respect to first repetition, or specifies which part of the OCC code to be used within the OCC code sequence. The code set with the configured length might either be pre-configured at the UE (from specifications) or be further RRC configured by gNB. The code set might be a set of Walsh-Hadamard sequences or a set of DFT sequences or another set of codes (binary or non-binary, where binary is considered as having two discrete states) that are providing inter-code orthogonality given that UE transmissions are synchronized.

In another embodiment, UE is configured to use OCC and a set of lengths of the OCC to use via RRC (semi-static) signaling. In this case, the OCC to use (length and code) is dynamically indicated to the UE via DCI either via a new DCI field or via repurposing an existing DCI field. The DCI field can further indicate an offset that specifies the OCC elements (or code) position with respect to first repetition, or specifies which part of the OCC code to be used within the OCC code sequence. In an alternative to this dynamic indication, a UE may be provided a table with different lengths and code entries, and the UE is dynamically indicated the specific row and/or column indexes to use. Upon knowing the row and/or column indexes the UE knows the specific OCC code and length to use for UL transmissions.

In another embodiment, UE is configured to use OCC via RRC (semi-static) signaling and the length of the OCC to use for a number of PUSCH repetitions is related to the number of PUSCH repetitions. In one alternative, the length of the OCC to use for a number of PUSCH repetitions is equal to the number of repetitions. In another alternative, the length of the OCC to use for a number of PUSCH repetitions is the closest power of 2 value lower than the number of repetitions. In yet another alternative the OCC code length may be configured such that the repetition number is divisible by the OCC code length (able to perform division without remainder, meaning that an integer amount of OCC codes can be applied over a repetition window). In one implementation based on the examples described herein, the UE may further be indicated an offset to apply on top of the indication of which code to use.

In one embodiment, a set of OCC codes to use (each per one or multiple numbers of PUSCH repetitions) is RRC configured and UE autonomously chooses the OCC to apply to the PUSCH transmission. Based on the number of scheduled PUSCH repetitions, UE uses the respective code in the set with for example a length of closest power of 2 value lower than the number of repetitions.

In another embodiment, UE is indicated the OCC to apply to the PUSCH transmission via DCI among the OCC codes with length as determined by first two bullets above. In one alternative, the DCI field is of variable size depending on the number of scheduled repetitions. In another alternative, the DCI field is of fixed size and equal to a max number of multiplexable UEs and the indication is based on a subset of (MSB) bits e.g. equal to log 2 (N_repetitions). In other words, based on the number of scheduled repetitions a subset of bits of the DCI field are “active” and contain the indication. In yet another alternative, an OCC code with a max length (this max length might be preconfigured at the UE) is RRC configured per UE and UE uses only a number of entries equal to the number of scheduled repetitions. If properly configured this solution works because you can always find an orthogonal N×N Walsh matrix within an orthogonal MxM Walsh matrix with M>N. M and N are power of 2.

In another embodiment, the UE may be configured to use a “windowing function” similar to the concept of time domain windows used for DMRS bundling, where a UE is committing to maintaining transmit phase over a given window. In an example, the boundaries of the time domain windows are aligned to the periodicity and phase of the OCC code, such that the UE commits to maintaining phase coherence at the receiver side (as is defined for NR over NTN systems as part of Rel-18) over a well-defined period of time.

In yet another embodiment the gNB may configure two or more UEs to use different code lengths, while still maintaining orthogonality between the UEs due to preferred pairing between various sequences.

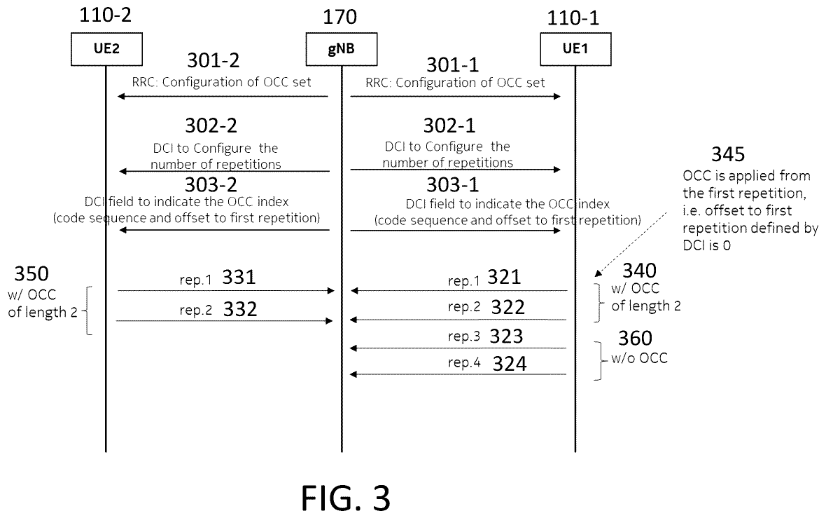

FIG. 3 shows signaling OCC using RRC and DCI fields. In particular, FIG. 3 shows a message sequence chart of an example implementation of the herein described solution based on RRC configured OCC set through which the OCC set, i.e. the elements of different orthogonal sequences, to be used by UEs (110-1, 110-2) are communicated and configured in a semi-static manner. This example includes 2 UEs to be multiplexed with OCC of size 2 (340, 350). The UE1 110-1 requires four repetitions (repetition 1 321, repetition 2 322, repetition 3 323, repetition 4 324) while UE2 110-2 is arranged with only two repetitions (repetition 1 331, repetition 2 332).

Step-by-step signaling is as follows:

1 (301-1, 301-2). RRC configures the UEs with OCC set to be potentially used such as [1 1], [1-1]. They can be put in a matrix of OCC codes in which each row represents one orthogonal sequence. In this example it is [1 1;1-1].

2 (302-1, 302-2). The gNB 170 informs the UEs (110-1, 110-2) the number of repetitions they require, i.e. via a TDRA (Time Domain Resource Allocation) table.

3 (303-1, 303-2). To multiplex UE1 110-1 and UE2 110-2 in the network, the gNB 170 further informs the users if they require to apply OCC to the repetitions and how. For this a DCI field can carry the necessary information that points to each UE which OCC sequence to apply and where the OCC should be applied. In FIG. 3, UE1 110-1 is indicated to apply OCC [1 1] to the first two repetitions, i.e. the start index refers to the first repetition and hence no offset exist with respect to first repetition, while the UE2 110-2 only requires to know which orthogonal code has to be used which here could be [1-1]. If the index DCI field is empty or takes a special configured value, one can assume no OCC is applied.

As further shown in FIG. 3, repetition 3 323 and repetition 4 324 are performed without OCC (360). As indicated at 345, the OCC for UE1 110-1 is applied from the first repetition, i.e. offset to the first repetition defined by DCI is 0.

The examples described herein allow more efficient use of repetitions through code multiplexing. In the above examples 2 UEs are able to share the same resources and hence release new resources for capacity increase. The solution is flexible in order to multiplex different UEs with different level of link budgets. In the example above, UE1 110-1 with the poorer link budget can apply OCC to only a portion of the repetitions in order to adapt to the other UE's conditions (conditions of UE 110-2) that only require 2 repetitions and hence OCC of size 2.

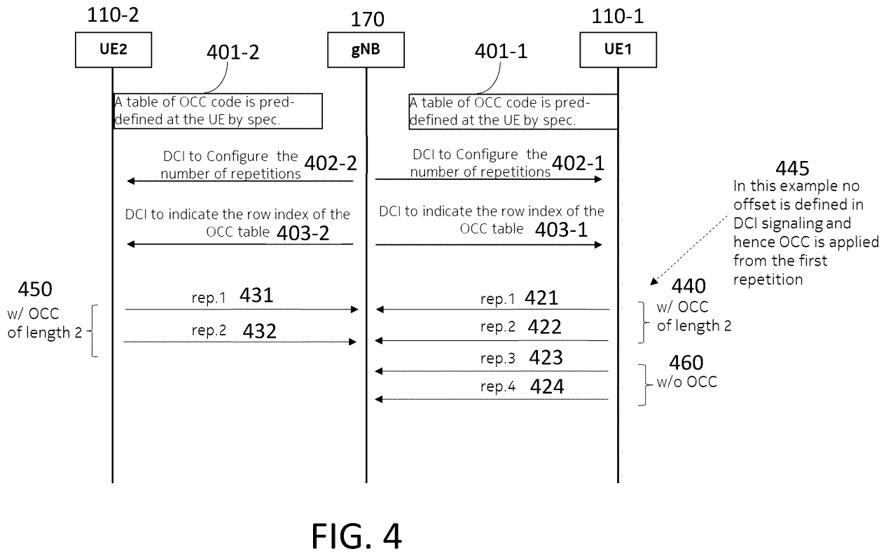

FIG. 4 shows signaling OCC when code sets at UEs are pre-defined by specification. In particular, FIG. 4 shows an example where the OCC set is pre-defined by specification and is known for all UEs. The steps are as follows:

1. Network decides to code-multiplex UE1 and UE2 with their number of repetitions. At 401-1, a table of one or more OCC codes is pre-defined at the UE1 110-1 by specification. At 401-2, a table of one or more OCC codes is pre-defined at the UE2 110-2 by specification.

2 (402-1, 402-2). Number of repetitions are communicated to UEs using DCI.

3 (403-1, 403-2). The new DCI field is used to indicate which row of the OCC table each UE (110-1, 110-2) has to use to make sure the size of OCC is appropriate and the codes of UE1 110-1 and UE2 110-2 are orthogonal.

4 (440, 450). UEs (110-1, 110-2) apply OCC from the first repetitions and hence (as indicated at 445) there is no need for the gNB 170 to specify from which repetition OCC is to be applied like the previous case.

FIG. 4 shows repetition 1 421, repetition 2 422, repetition 3 423, and repetition 4 424 performed with UE1 110-1, where the OCC of length 2 440 includes repetition 1 421 and repetition 2 422, and where repetition 3 423 and repetition 4 424 are performed without OCC as indicated at 460. Repetition 1 431 and repetition 2 432 are performed with UE2 110-2 with OCC of length 2 450.

The examples described herein are relevant to 3GPP NTN WI on UL capacity and throughput enhancements via OCC, and may be applicable to TS 38.214 for UE behavior and TS 38.331 for configuration of relevant parameters.

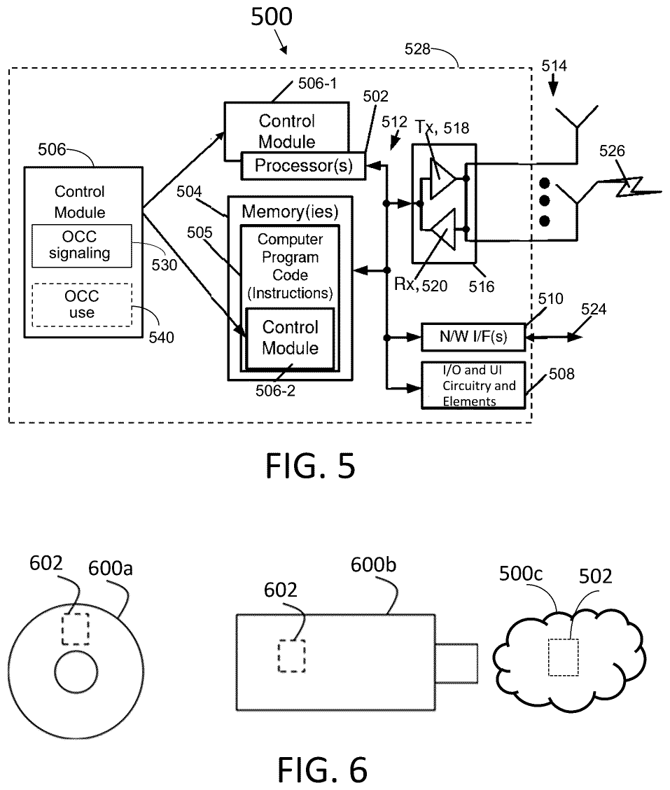

FIG. 5 is an example apparatus 500, which may be implemented in hardware, configured to implement the examples described herein. The apparatus 500 comprises at least one processor 502 (e.g. an FPGA and/or CPU), one or more memories 504 including computer program code 505, the computer program code 505 having instructions to carry out the methods described herein, wherein the at least one memory 504 and the computer program code 405 are configured to, with the at least one processor 402, cause the apparatus 400 to implement circuitry, a process, component, module, or function (implemented with control module 406) to implement the examples described herein. The memory 405 may be a non-transitory memory, a transitory memory, a volatile memory (e.g. RAM), or a non-volatile memory (e.g. ROM).

OCC signaling 530 and optionally included OCC use 540 may implement the examples described herein related to signaling for OCC-enabled PUSCH.

The apparatus 500 includes a display and/or I/O interface 508, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 500 includes one or more communication e.g. network (N/W) interfaces (I/F(s)) 510. The communication I/F(s) 510 may be wired and/or wireless and communicate over the Internet/other network(s) via any communication technique including via one or more links 524. The link(s) 524 may be the link(s) 131 and/or 176 from FIG. 1. The link(s) 131 and/or 176 from FIG. 1 may also be implemented using transceiver(s) 516 and corresponding wireless link(s) 526. The communication I/F(s) 510 may comprise one or more transmitters or one or more receivers.

The transceiver 516 comprises one or more transmitters 518 and one or more receivers 520. The transceiver 516 and/or communication I/F(s) 510 may comprise standard well-known components such as an amplifier, filter, frequency-converter, (de) modulator, and encoder/decoder circuitries and one or more antennas, such as antennas 514 used for communication over wireless link 526.

The control module 506 of the apparatus 500 comprises one of or both parts 506-1 and/or 506-2, which may be implemented in a number of ways. The control module 506 may be implemented in hardware as control module 506-1, such as being implemented as part of the one or more processors 502. The control module 506-1 may be implemented also as an integrated circuit or through other hardware such as a programmable gate array. In another example, the control module 506 may be implemented as control module 506-2, which is implemented as computer program code (having corresponding instructions) 505 and is executed by the one or more processors 502. For instance, the one or more memories 504 store instructions that, when executed by the one or more processors 502, cause the apparatus 500 to perform one or more of the operations as described herein. Furthermore, the one or more processors 502, the one or more memories 504, and example algorithms (e.g., as flowcharts and/or signaling diagrams), encoded as instructions, programs, or code, are means for causing performance of the operations described herein.

The apparatus 500 to implement the functionality of control 506 may be UE 110, RAN node 170 (e.g. gNB), or network element(s) 190 (e.g. LMF 190). Thus, processor 502 may correspond to processor(s) 120, processor(s) 152 and/or processor(s) 175, memory 504 may correspond to one or more memories 125, one or more memories 155 and/or one or more memories 171, computer program code 505 may correspond to computer program code 123, computer program code 153, and/or computer program code 173, control module 506 may correspond to module 140-1, module 140-2, module 150-1, and/or module 150-2, and communication I/F(s) 510 and/or transceiver 516 may correspond to transceiver 130, antenna(s) 128, transceiver 160, antenna(s) 158, N/W I/F(s) 161, and/or N/W I/F(s) 180. Alternatively, apparatus 500 and its elements may not correspond to either of UE 110, RAN node 170, or network element(s) 190 and their respective elements, as apparatus 500 may be part of a self-organizing/optimizing network (SON) node or other node, such as a node in a cloud.

Apparatus 500 may correspond to UE1 110-1 or UE2 110-2, where UE1 110-1 and UE2 110-2 are configured similar to UE 110.

The apparatus 500 may also be distributed throughout the network (e.g. 100) including within and between apparatus 500 and any network element (such as a network control element (NCE) 190 and/or the RAN node 170 and/or UE 110).

Interface 512 enables data communication and signaling between the various items of apparatus 500, as shown in FIG. 5. For example, the interface 512 may be one or more buses such as address, data, or control buses, and may include any interconnection mechanism, such as a series of lines on a motherboard or integrated circuit, fiber optics or other optical communication equipment, and the like. Computer program code (e.g. instructions) 505, including control 506 may comprise object-oriented software configured to pass data or messages between objects within computer program code 505, or computer program code (e.g. instructions) 505, including control 506 may include functional, scripting, or procedural code. The apparatus 500 need not comprise each of the features mentioned, or may comprise other features as well. The various components of apparatus 500 may at least partially reside in a common housing 528, or a subset of the various components of apparatus 500 may at least partially be located in different housings, which different housings may include housing 528.

FIG. 6 shows a schematic representation of non-volatile memory media 600a (e.g. computer/compact disc (CD) or digital versatile disc (DVD)) and 600b (e.g. universal serial bus (USB) memory stick) and 600c (e.g. cloud storage for downloading instructions and/or parameters 602 or receiving emailed instructions and/or parameters 602) storing instructions and/or parameters 602 which when executed by a processor allows the processor to perform one or more of the steps of the methods described herein. Instructions and/or parameters 602 may represent a non-transitory computer readable medium.

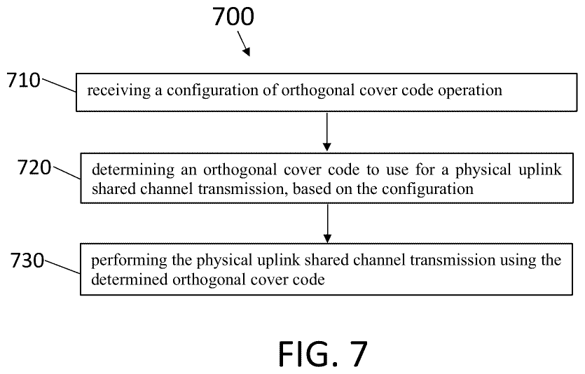

FIG. 7 is an example method 700 based on the examples described herein. At 710, the method includes receiving a configuration of orthogonal cover code operation. At 720, the method includes determining an orthogonal cover code to use for a physical uplink shared channel transmission, based on the configuration. At 730, the method includes performing the physical uplink shared channel transmission using the determined orthogonal cover code. Method 700 may be performed with UE 110 or apparatus 500.

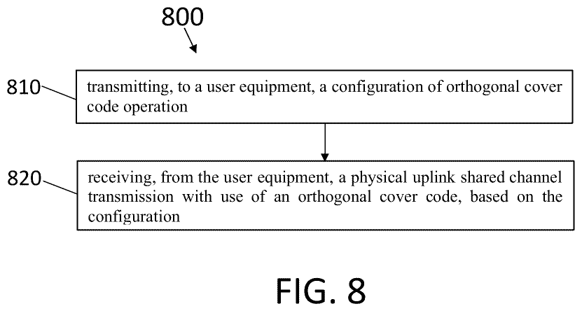

FIG. 8 is an example method 800 based on the examples described herein. At 810, the method includes transmitting, to a user equipment, a configuration of orthogonal cover code operation. At 820, the method includes receiving, from the user equipment, a physical uplink shared channel transmission with use of an orthogonal cover code, based on the configuration. Method 800 may be performed with RAN node 170, one or more network elements 190, or apparatus 500.

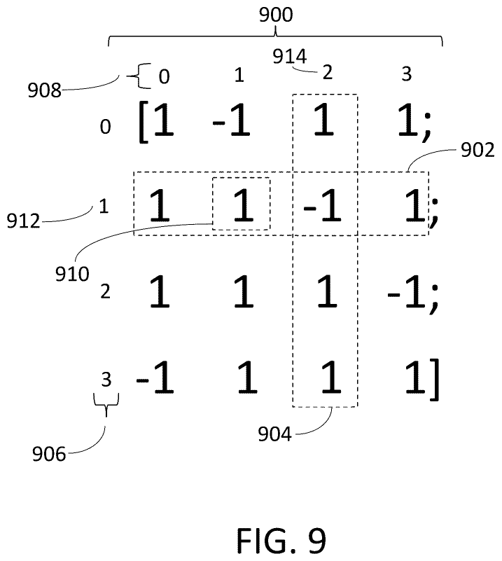

FIG. 9 shows an example OCC configuration 900. The example OCC configuration 900 is shown in FIG. 9 as a 4*4 table/matrix with the matrix elements equal to elements of OCC code sets (or to elements of OCC codes). In FIG. 9, there are 4 orthogonal cover codes of length 4 placed in 4 rows in the matrix and the index refers to the row of the matrix. The configuration has a row index (one of 906). As shown, orthogonal cover code 902 is specified by row index 1 (912), and includes OCC sequence 1, 1,−1, 1 (from left to right). In some examples the index also can refer to the column (one of 908). As shown, orthogonal cover code 904 is specified by column index 2 (914), and includes OCC sequence 1,−1, 1, 1 (from top to bottom). The offset also can be preconfigured, and the offset may be indicated by DCI. As shown, element or entry 910 (with value 1) of orthogonal cover code 902 is specified with row index 1 and an offset of 1 corresponding to column index 1 in the matrix. An orthogonal cover code set may include only one OCC, such as orthogonal cover code 902, or an orthogonal cover code set may include a plurality of orthogonal cover codes (OCCs), such as OCC 902 and OCC 904. OCC configuration 900 may be signaled by the network (e.g. RAN node 170 or one or more network elements 190) to one UE 110 or to a plurality of user equipments (UEs) including UE 110. For example, the network may signal to UE 110 to use OCC 902 or one or more of the elements of OCC 902, and may signal to another UE different from UE 110 to use OCC 904 or one or more elements of the OCC 904, where UE 110 and the another UE receive the same OCC configuration 900.

The following examples are provided and described herein.

Example 1. An apparatus including: means for receiving a configuration of orthogonal cover code operation; means for determining an orthogonal cover code to use for a physical uplink shared channel transmission, based on the configuration; and means for performing the physical uplink shared channel transmission using the determined orthogonal cover code.

Example 2. The apparatus of example 1, wherein the configuration comprises an orthogonal cover code set comprising a plurality of orthogonal cover codes, wherein each orthogonal cover code within the orthogonal cover code set has a length determined based on a number of entries of the orthogonal cover code.

Example 3. The apparatus of example 2, wherein an entry of the orthogonal cover code comprises a coefficient to apply to a data part of the physical uplink shared channel transmission when using the orthogonal cover code.

Example 4. The apparatus of any of examples 2 to 3, wherein the orthogonal cover code comprises a sequence of coefficients to apply to a sequence of physical uplink shared channel transmissions when using the orthogonal cover code.

Example 5. The apparatus of any of examples 1 to 4, wherein the configuration comprises a plurality of orthogonal cover code sets.

Example 6. The apparatus of any of examples 1 to 5, further including: means for determining repetitions of physical uplink shared channel transmissions to perform using the orthogonal cover code.

Example 7. The apparatus of any of examples 1 to 6, further including: means determining repetitions of physical uplink shared channel transmissions to perform without use of the orthogonal cover code.

Example 8. The apparatus of any of examples 1 to 7, further including: means for determining an index of the configuration that specifies the orthogonal cover code to use for the physical uplink shared channel transmission.

Example 9. The apparatus of example 8, wherein the index specifies an orthogonal cover code to use for at least a first repetition of the repetitions of the physical uplink shared channel transmissions.

Example 10. The apparatus of any of examples 1 to 9, further including: means for determining an offset of the configuration, where the offset specifies an entry of the orthogonal cover code to use for the physical uplink shared channel transmission.

Example 11. The apparatus of any of examples 1 to 10, wherein the configuration of orthogonal cover code operation is provided as a table and given with a specification.

Example 12. The apparatus of example 11, further including: means for determining a location within the table where the orthogonal cover code that the apparatus is to use is located.

Example 13. The apparatus of any of examples 11 to 12, further including: means for determining an indication that specifies a row of the table where the orthogonal cover code that the apparatus is to use is located.

Example 14. The apparatus of any of examples 1 to 13, further including: means for receiving, from a network an indication of repetitions of physical uplink shared channel transmissions to perform using the orthogonal cover code based on a link budget of the apparatus.

Example 15. The apparatus of example 14, wherein a number of the repetitions of the physical uplink shared channel transmissions the apparatus is indicated to perform when the apparatus has a first link budget is less than a number of the repetitions of the physical uplink shared channel transmissions the apparatus is indicated to perform when the apparatus has a second link budget, wherein the first link budget is smaller than the second link budget.

Example 16. The apparatus of any of examples 1 to 15, further including: means for transmitting, to a network, an indication of a capability of the apparatus to use an orthogonal cover code.

Example 17. The apparatus of any of examples 1 to 16, further including: means for receiving, from a network, an indication of the orthogonal cover code to use.

Example 18. The apparatus of any of examples 1 to 17, further including: means for receiving, from a network, an indication of repetitions of physical uplink shared channel transmissions to perform using the orthogonal cover code.

Example 19. The apparatus of any of examples 1 to 18, further including: means for receiving, from a network, an indication of the orthogonal cover code to use for a number of repetitions of physical uplink shared channel transmissions; wherein a length of the orthogonal cover code indicated to be used for the number of physical uplink shared channel transmissions is the closest power of 2 value lower than the number of repetitions; and means for using the orthogonal cover code for the number of repetitions of the physical uplink shared channel transmissions.

Example 20. The apparatus of any of examples 1 to 19, wherein the apparatus comprises a user equipment, or a user equipment comprises the apparatus.

Example 21. An apparatus including: means for transmitting, to a user equipment, a configuration of orthogonal cover code operation; and means for receiving, from the user equipment, a physical uplink shared channel transmission with use of an orthogonal cover code, based on the configuration.

Example 22. The apparatus of example 21, wherein the configuration comprises an orthogonal cover code set comprising a plurality of orthogonal cover codes, wherein each orthogonal cover code within the orthogonal cover code set has a length determined based on a number of entries of the orthogonal cover code.

Example 23. The apparatus of example 22, wherein an entry of the orthogonal cover code comprises a coefficient to apply to a data part of the physical uplink shared channel transmission with use of the orthogonal cover code.

Example 24. The apparatus of any of examples 22 to 23, wherein the orthogonal cover code comprises a sequence of coefficients to apply to a sequence of physical uplink shared channel transmissions with use of the orthogonal cover code.

Example 25. The apparatus of any of examples 21 to 24, wherein the configuration comprises a plurality of orthogonal cover code sets.

Example 26. The apparatus of any of examples 21 to 25, further including: means for transmitting, to the user equipment, an indication of repetitions of physical uplink shared channel transmissions to perform using the orthogonal cover code.

Example 27. The apparatus of any of examples 21 to 26, further including: means for transmitting, to the user equipment, an indication of repetitions of physical uplink shared channel transmissions to perform without use of the orthogonal cover code.

Example 28. The apparatus of any of examples 21 to 27, further including: means for transmitting, to the user equipment, an index of the configuration that specifies the orthogonal cover code to use for the physical uplink shared channel transmission.

Example 29. The apparatus of example 28, wherein the index specifies the orthogonal cover code to use for at least a first repetition of the repetitions of the physical uplink shared channel transmissions.

Example 30. The apparatus of any of examples 21 to 29, further including: means for transmitting, to the user equipment, an offset of the configuration, where the offset specifies an entry of the orthogonal cover code to use for the physical uplink shared channel transmission.

Example 31. The apparatus of any of examples 21 to 30, wherein the configuration of orthogonal cover code operations is provided as a table and given with a specification.

Example 32. The apparatus of example 31, further including: means for transmitting, to the user equipment, a location within the table where the orthogonal cover code that the user equipment is to use is located.

Example 33. The apparatus of any of examples 31 to 32, further including: means for transmitting, to the user equipment, an indication of a row of the table where the orthogonal cover code that the user equipment is to use is located.

Example 34. The apparatus of any of examples 21 to 33, further including: means for determining a link budget of a first user equipment; means for determining a link budget of a second user equipment; means for transmitting, to the first user equipment, an indication of repetitions of physical uplink shared channel transmissions to perform using a first orthogonal cover code, based on the link budget of the first user equipment; and means for transmitting, to the second user equipment, an indication of repetitions of physical uplink shared channel transmissions to perform using a second orthogonal cover code, based on the link budget of the second user equipment.

Example 35. The apparatus of example 34, wherein a number of the repetitions of the physical uplink shared channel transmissions to perform transmitted to the first user equipment is less than a number of repetitions of the physical uplink shared channel transmissions to perform transmitted to the second user equipment, when the link budget of the first user equipment is smaller than the link budget of the second user equipment.

Example 36. The apparatus of any of examples 21 to 35, further including: means for receiving, from the user equipment, an indication of a capability of the user equipment to use an orthogonal cover code.

Example 37. The apparatus of any of examples 21 to 36, further including: means for transmitting, to the user equipment, an indication of the orthogonal cover code to use.

Example 38. The apparatus of any of examples 21 to 37, further including: means for transmitting, to the user equipment, an indication of repetitions of physical uplink shared channel transmissions to perform using the orthogonal cover code.

Example 39. The apparatus of any of examples 21 to 38, further including: means for transmitting, to the user equipment, an indication of the orthogonal cover code to use for a number of physical uplink shared channel transmissions; wherein a length of the orthogonal cover code indicated to be used for the number of physical uplink shared channel transmissions is the closest power of 2 value lower than the number of repetitions.

Example 40. The apparatus of any of examples 21 to 39, wherein: the apparatus comprises a radio access network node, or a radio access network node comprises the apparatus, the apparatus comprises a core network element, or a core network element comprises the apparatus.

Example 41. A method including: receiving a configuration of orthogonal cover code operation; determining an orthogonal cover code to use for a physical uplink shared channel transmission, based on the configuration; and performing the physical uplink shared channel transmission using the determined orthogonal cover code.

Example 42. A method including: transmitting, to a user equipment, a configuration of orthogonal cover code operation; and receiving, from the user equipment, a physical uplink shared channel transmission with use of an orthogonal cover code, based on the configuration.

Example 43. A computer readable medium including instructions stored thereon for performing at least the following: receiving a configuration of orthogonal cover code operation; determining an orthogonal cover code to use for a physical uplink shared channel transmission, based on the configuration; and performing the physical uplink shared channel transmission using the determined orthogonal cover code.

Example 44. A computer readable medium including instructions stored thereon for performing at least the following: transmitting, to a user equipment, a configuration of orthogonal cover code operation; and receiving, from the user equipment, a physical uplink shared channel transmission with use of an orthogonal cover code, based on the configuration.

Example 45. An apparatus including: at least one processor; and at least one memory storing instructions that, when executed by the at least one processor, cause the apparatus at least to: receive a configuration of orthogonal cover code operation; determine an orthogonal cover code to use for a physical uplink shared channel transmission, based on the configuration; and perform the physical uplink shared channel transmission using the determined orthogonal cover code.

Example 46. An apparatus including: at least one processor; and at least one memory storing instructions that, when executed by the at least one processor, cause the apparatus at least to: transmit, to a user equipment, a configuration of orthogonal cover code operation; and receive, from the user equipment, a physical uplink shared channel transmission with use of an orthogonal cover code, based on the configuration.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended/combined with each other or with other characters using e.g. a dash, hyphen, slash, letter, or number, and may be case insensitive):
3GPP third generation partnership project
4G fourth generation
5G fifth generation
5GC 5G core network
AMF access and mobility management function
ASIC application-specific integrated circuit
CD compact/computer disc
CPU central processing unit
CU central unit or centralized unit
DCI downlink control information
DFT discrete Fourier transform
DFT-s-OFDM DFT spread orthogonal frequency division multiplexing
DMRS demodulation reference signal
DSP digital signal processor
DU distributed unit
DVD digital versatile disc
eNB evolved Node B (e.g., an LTE base station)
EN-DC E-UTRAN new radio-dual connectivity
en-gNB node providing NR user plane and control plane protocol terminations towards the UE, and acting as a secondary node in EN-DC
E-UTRA evolved UMTS terrestrial radio access, i.e., the LTE radio access technology
E-UTRAN E-UTRA network
F1 interface between the CU and the DU
FPGA field-programmable gate array
FR1-NTN frequency range 1 non-terrestrial networks
gNB generalized node B, base station for 5G/NR, i.e., a node providing NR user plane and control plane protocol terminations towards the UE, and connected via the NG interface to the 5GC
IAB integrated access and backhaul
I/F interface
I/O input/output
LMF location management function
LTE long term evolution (4G)
MAC medium access control
MIMO multiple input multiple output
MME mobility management entity
MRO mobility robustness optimization
MSB most significant bit
MU-MIMO multiuser MIMO
NCE network control element
ng or NG new generation
ng-eNB new generation eNB
NG-RAN new generation radio access network
NR new radio
NTN non-terrestrial networks
N/W network
OCC orthogonal cover code
OFDM orthogonal frequency division multiplexing
PDA personal digital assistant
PDCP packet data convergence protocol
PHY physical layer
PRACH physical random access channel
PUSCH physical uplink shared channel
RAM random access memory
RAN radio access network
RAN #RAN meeting
RAN1 RAN working group 1
RAN2 RAN working group 2
RAN4 RAN working group 4
rep. repetition
Rel release
RF radio frequency
RLC radio link control
ROM read-only memory
RP RAN plenary
RRC radio resource control
RU radio unit
Rx receive, or receiver, or reception
SDAP service data adaptation protocol
SGW serving gateway
SMF session management function
SON self-organizing/optimizing network
TDRA time domain resource allocation
TRP transmission reception point
TS technical specification
Tx transmit, or transmitter, or transmission
UAV unmanned aerial vehicle
UE user equipment (e.g., a wireless, typically mobile device)
UI user interface
UL uplink
UMTS Universal Mobile Telecommunications System
UPF user plane function
USB universal serial bus
WI work item
WID work item description
X2 network interface between RAN nodes and between RAN and the core network
Xn network interface between NG-RAN nodes

What is claimed is:

1. An apparatus comprising:
at least one processor; and
at least one memory including computer program code, the at least one memory and the computer program code being configured to, with the at least one processor, cause the apparatus at least to:
receive a configuration of orthogonal cover code operation, wherein the configuration comprises plural orthogonal cover codes, each respective orthogonal cover code of the plural orthogonal cover codes having a length defined by a number of entries of the respective orthogonal cover code, and wherein an entry of the respective orthogonal cover code comprises a coefficient to be applied to a data part of a physical uplink shared channel transmission when using the orthogonal cover code;
determine an orthogonal cover code to use for the physical uplink shared channel transmission, based on the configuration; and
perform the physical uplink shared channel transmission using the determined orthogonal cover code.

2. The apparatus of claim 1, wherein the at least one memory and the computer program code are configured to, with the at least one processor, cause the apparatus to:
determine an index of the configuration that specifies the orthogonal cover code to use for the physical uplink shared channel transmission.

3. The apparatus of claim 1, wherein the at least one memory and the computer program code are configured to, with the at least one processor, cause the apparatus to:
determine an offset of the configuration, where the offset specifies an entry of the orthogonal cover code to use for the physical uplink shared channel transmission.

4. The apparatus of claim 1, wherein the at least one memory and the computer program code are configured to, with the at least one processor, cause the apparatus to:
determine a location of the orthogonal cover code that the apparatus is to use within a table;
wherein the configuration of orthogonal cover code operation is provided as the table.

5. The apparatus of claim 1, wherein the at least one memory and the computer program code are configured to, with the at least one processor, cause the apparatus to:
receive from a network an indication of repetitions of physical uplink shared channel transmissions to perform using the orthogonal cover code based on a link budget of the apparatus;
wherein a number of the repetitions of the physical uplink shared channel transmissions the apparatus is indicated to perform when the apparatus has a first link budget is less than a number of the repetitions of the physical uplink shared channel transmissions the apparatus is indicated to perform when the apparatus has a second link budget, wherein the first link budget is smaller than the second link budget.

6. The apparatus of claim 1, wherein the at least one memory and the computer program code are configured to, with the at least one processor, cause the apparatus to:
transmit, to a network, an indication of a capability of the apparatus to use an orthogonal cover code.

7. The apparatus of claim 1, wherein the at least one memory and the computer program code are configured to, with the at least one processor, cause the apparatus to:
receive, from a network, an indication of the orthogonal cover code to use.

8. The apparatus of claim 1, wherein the at least one memory and the computer program code are configured to, with the at least one processor, cause the apparatus to:
receive, from a network, an indication of the orthogonal cover code to use for a number of repetitions of physical uplink shared channel transmissions; and
use the orthogonal cover code for the number of repetitions of the physical uplink shared channel transmissions;
wherein a length of the orthogonal cover code indicated to be used for the number of physical uplink shared channel transmissions is a power of 2 value closest to and lower than the number of repetitions.

9. An apparatus comprising:
at least one processor; and
at least one memory including computer program code, the at least one memory and the computer program code being configured to, with the at least one processor, cause the apparatus at least to:
transmit, to a user equipment, a configuration of orthogonal cover code operation, wherein the configuration comprises plural orthogonal cover codes, each respective orthogonal cover code of the plural orthogonal cover codes having a length defined by a number of entries of the respective orthogonal cover code, and wherein an entry of the respective orthogonal cover code comprises a coefficient to be applied to a data part of a physical uplink shared channel transmission when using the orthogonal cover code; and
receive, from the user equipment, a physical uplink shared channel transmission using an orthogonal cover code, based on the configuration.

10. The apparatus of claim 9, wherein the at least one memory and the computer program code are configured to, with the at least one processor, cause the apparatus to:
transmit, to the user equipment, an index of the configuration that specifies the orthogonal cover code to use for the physical uplink shared channel transmission.

11. The apparatus of claim 9, wherein the at least one memory and the computer program code are configured to, with the at least one processor, cause the apparatus to:
transmit, to the user equipment, an offset of the configuration, where the offset specifies an entry of the orthogonal cover code to use for the physical uplink shared channel transmission.

12. The apparatus of claim 9, wherein the at least one memory and the computer program code are configured to, with the at least one processor, cause the apparatus to:
transmit, to the user equipment, a location of the orthogonal cover code that the user equipment is to use within a table;
wherein the configuration of orthogonal cover code operations is provided as the table.

13. The apparatus of claim 9, wherein the at least one memory and the computer program code are configured to, with the at least one processor, cause the apparatus to:
determine a link budget of a first user equipment;
determine a link budget of a second user equipment;
transmit, to the first user equipment, an indication of repetitions of physical uplink shared channel transmissions to perform using a first orthogonal cover code, based on the link budget of the first user equipment; and
transmit, to the second user equipment, an indication of repetitions of physical uplink shared channel transmissions to perform using a second orthogonal cover code, based on the link budget of the second user equipment;
wherein a number of the repetitions of the physical uplink shared channel transmissions to perform transmitted to the first user equipment is less than a number of repetitions of the physical uplink shared channel transmissions to perform transmitted to the second user equipment and the link budget of the first user equipment is smaller than the link budget of the second user equipment.

14. The apparatus of claim 9, wherein the at least one memory and the computer program code are configured to, with the at least one processor, cause the apparatus to:
receive, from the user equipment, an indication of a capability of the user equipment to use an orthogonal cover code.

15. The apparatus of claim 9, wherein the at least one memory and the computer program code are configured to, with the at least one processor, cause the apparatus to:
transmit, to the user equipment, an indication of the orthogonal cover code to use.

16. A method comprising:
receiving, by a user equipment from a network node, a configuration of orthogonal cover code operation, wherein the configuration comprises plural orthogonal cover codes, each respective orthogonal cover code of the plural orthogonal cover codes having a length defined by a number of entries of the respective orthogonal cover code, and wherein an entry of the respective orthogonal cover code comprises a coefficient to be applied to a data part of a physical uplink shared channel transmission when using the orthogonal cover code;
determining, by the user equipment, an orthogonal cover code to use for the physical uplink shared channel transmission, based on the configuration; and
performing, by the user equipment, the physical uplink shared channel transmission using the determined orthogonal cover code.

17. The method of claim 16, further comprising:
determining, by the user equipment, an index of the configuration that specifies the orthogonal cover code to use for the physical uplink shared channel transmission.

18. The method of claim 16, further comprising:
determining, by the user equipment, an offset of the configuration, where the offset specifies an entry of the orthogonal cover code to use for the physical uplink shared channel transmission.

19. The method of claim 16, further comprising:
determining, by the user equipment, a location of the orthogonal cover code that the user equipment is to use within a table;
wherein the configuration of orthogonal cover code operation is provided as the table.

20. The method of claim 16, further comprising:
receiving, by the user equipment from a network node, an indication of repetitions of physical uplink shared channel transmissions to perform using the orthogonal cover code based on a link budget of the user equipment;
wherein a number of the repetitions of the physical uplink shared channel transmissions the user equipment is indicated to perform when the user equipment has a first link budget is less than a number of the repetitions of the physical uplink shared channel transmissions the user equipment is indicated to perform when the user equipment has a second link budget, wherein the first link budget is smaller than the second link budget.
